(19) United States
(12) Patent Application Publication
(10) Pub. No.: US 2019/0309646 A1
(43) Pub. Date: Oct. 10, 2019

(54) TURBINE TEMPERATURE ESTIMATION SYSTEM

(71) Applicant: DOOSAN HEAVY INDUSTRIES & CONSTRUCTION CO., LTD., Changwon-si (KR)

(72) Inventor: Geon Hwan Cho, Gimhae-si (KR)

(21) Appl. No.: 16/278,746

(22) Filed: Feb. 19, 2019

(30) Foreign Application Priority Data
Apr. 5, 2018 (KR) 10-2018-0039631

(51) Int. Cl. F01D 17/08; F01D 25/12; G01K 7/18

(52) U.S. Cl. CPC F01D 17/085; F01D 25/12; G01K 7/183; G01K 2205/00; F05D 2300/143; F05D 2270/80; F05D 2270/303; F05D 2260/211; F05D 2300/611; F05D 2240/15

(57) ABSTRACT

A turbine temperature estimation system controls a valve in a cooling passage to control the flow rate of cooling air supplied to a turbine component on the basis of its temperature. The system includes a coating layer formed on a surface of a component of the gas turbine; a measuring unit to supply an electric current to the coating layer and to measure a change in a resistance value of the coating layer; and a controller to estimate a temperature of the coating layer on the basis of the resistance value. The coating layer includes a heat shielding material and a resistive material whose resistance value changes with temperature. A cooling passage supplies cooling air to cool the turbine component, and the controller controls an opening of the cooling passage according to a voltage value of the coating layer.

### CROSS REFERENCE TO RELATED APPLICATIONS

The present application claims priority to Korean Patent Application No. 10-2018-0039631, filed Apr. 5, 2018, the entire contents of which is incorporated herein for all purposes by this reference.

### BACKGROUND OF THE INVENTION

### 1. Field of the Invention

The present invention relates to a system for estimating the temperature of a turbine by measuring the resistance of a coating layer.

### 2. Description of the Background Art

Generally, a turbine refers to a rotary mechanical device that extracts energy from a fluid, such as water, gas, or vapor, and transforms the extracted energy into useful mechanical work. A turbine also means a turbo-machine with at least one moving part called a rotor assembly, which is a shaft with blades or vanes attached. A fluid is ejected to impact the blades or vanes or to cause a reaction force of the blades or vanes, thereby moving the rotor assembly at high speed.

A gas turbine, which is one type of turbine, includes a compressor, a combustor, a turbine, and a rotor. A gas turbine works on the principle that a mixture of fuel and compressed air is burned to generate powerful energy that moves the turbine.

One power generation apparatus using a gas turbine includes multiple combustors provided with respective fuel nozzles. A mixture of fuel and air is injected into each combustor through a fuel supply nozzle to generate a high temperature flame. The heat of the high temperature flame increases the temperature of turbine blades and other components of the power generation apparatus.

Although most of the components of a gas turbine are made of superior heat resistant materials, when the components of a gas turbine are exposed to extreme temperatures for a long period, the service lives of the components are reduced. To solve this problem, a portion of compressed air generated by a compressor is supplied to turbine blades or some other components in a power generation apparatus. In this way, temperature soaring of the components of a power generation apparatus is prevented.

However, since the components of a turbine are usually exposed to a high temperature environment, there is a problem that it is difficult to directly measure the temperature of the components of a turbine. However, when an abnormal increase in the temperature of the components of a turbine cannot be detected, there is a problem that a cooling system cannot efficiently and properly work.

### SUMMARY OF THE INVENTION

The present invention has been made in view of the problems occurring in the related art, and an object of the present invention is to provide a turbine temperature estimation system for estimating the temperature of a component of a turbine on the basis of the resistance of a coating layer on the surface of the component of the turbine.

Another object of the present invention is to provide a turbine temperature estimation system for controlling a valve in a cooling passage to control the flow rate of cooling air supplied to a component of a turbine on the basis of the temperature of the component of the turbine.

In an aspect of the present invention, a turbine temperature estimation system is provided. The system may include a coating layer formed on a surface of a component of the gas turbine; a measuring unit configured to supply an electric current to the coating layer and to measure a change in a resistance value of the coating layer; and a controller configured to estimate a temperature of the coating layer on the basis of the resistance value. The coating layer may include a heat shielding material and a resistive material whose resistance value changes with temperature.

The system may further include a cooling passage for supplying cooling air to cool the component of the gas turbine, and the controller may be further configured to control an opening of the cooling passage according to a voltage value of the coating layer. The system may further include a valve provided in the cooling passage, and the controller may be further configured to control an opening degree of the valve by increasing the opening degree when the temperature of the component of the gas turbine is higher than a design value and by decreasing the opening degree when the temperature of the component of the gas turbine is lower than the design value.

The component of the gas turbine may include a blade, a vane, and/or a casing. The cooling passage may supply cooling air to the blade, vane, and/or casing; and the measuring unit measures the resistance value of the coating layer formed on an outer surface of the blade, on an outer surface of the vane, and/or on an inner surface of the casing.

The system may further include a data storage device for storing a temperature table in which resistance values of the coating layer and temperatures of the component of the gas turbine are mapped, and the controller may estimate the temperature of the component of the gas turbine by finding a temperature associated with a voltage value of the coating layer from the temperature table.

The resistive material may include one of platinum, platinum-rhodium, platinum-iridium, nickel, and a tungsten oxide.

The resistive material may be embedded in the coating layer and have a wire form, and the measuring unit may supply an electric current to the resistive material and may measure a resistance value of the resistance material which changes according to the temperature of the coating layer.

In another aspect of the present invention, a turbine temperature estimation system is provided. The system may include a coating layer formed on a surface of a component of the turbine; a measuring unit configured to supply an electric current to the coating layer and to measure a change in a resistance value of the coating layer; a controller configured to estimate a temperature of the coating layer on the basis of the resistance value; and a cooling passage for cooling the component of the turbine. The coating layer may include a heat shielding material and a resistive material whose resistance value changes according to a temperature, and the controller may be configured to control an opening of the cooling passage according to a voltage value of the coating layer.

The cooling passage may include a plurality of external cooling passages for bleeding air from a compressor to an outside of a compressor casing and for supplying the air to the turbine; an outlet-side cooling passage for bleeding air from an outlet of the compressor and supplying the air to the turbine; a connection cooling passage provided between a turbine blade and a turbine vane provided in a same stage; and a turbine cooling passage for supplying air to an inside of the turbine.

The coating layer may be disposed on a surface of a first stage turbine vane of the turbine, on a surface of a first stage turbine blade of the turbine, and/or on a surface of a turbine blade and a surface of a turbine vane other than a first stage turbine blade and a first stage turbine vane. According to the resistance value of the coating layer which is measured by the measuring unit, the controller may control an opening of the connection cooling passage and may further control an opening of an outlet-side external cooling passage for cooling the first stage cooling vane and/or blade of the outlet-side cooling passages. In addition, or in the alternative, the coating layer may be disposed on a surface of a casing of the turbine, and the controller may control an opening of the cooling passage according to the resistance value of the coating layer which is measured by the measuring unit.

In other words, the coating layer may be disposed on a surface of at least one of a turbine blade, a turbine vane, and a casing of the turbine, and the controller may obtain the resistance value of the coating layer disposed on the surface of at least one of the turbine blade, the turbine vane, and the casing of the turbine from the measuring unit. The controller may control at least one of the external cooling passage, the outlet-side cooling passage, the connection cooling passage, and the turbine cooling passage to cool at least one component of the turbine blade, the turbine vane, and the casing of the turbine according to the resistance value of the coating layer.

According to the present invention, it is possible to estimate the temperature of one component of a turbine by measuring the resistance value of the coating layer formed on the surface of the component of the turbine. Therefore, the operator can effectively obtain the temperature of one component of the turbine that operates in a high temperature environment. The controller can control the valve in the cooling passage to effectively cool one component of a turbine on the basis of the temperature of the component. Accordingly, a system capable of cooling one component of a turbine having a temperature higher than the design value can be implemented.

### BRIEF DESCRIPTION OF THE DRAWINGS

FIG. 1 is a cross-sectional view of a gas turbine according to an embodiment of the present invention;

FIG. 2 is a cross-sectional view illustrating a cooling system of the gas turbine of FIG. 1;

FIG. 3 is an enlarged view of a region inside a casing of FIG. 1;

FIG. 4 is a block diagram illustrating a temperature estimation system for a turbine, according to an embodiment of the present invention; and

FIG. 5 is a flowchart illustrating a method of estimating the temperature of a turbine according to an embodiment of the present invention.

### DETAILED DESCRIPTION OF THE DISCLOSURE

The advantages and features of the invention and the manner of achieving them will become apparent with reference to embodiments in detail below and the accompanying drawings. The invention may, however, be embodied in many different forms and should not be construed as being limited to the embodiments set forth herein. Rather, these embodiments are provided so that the invention will be thorough and complete and will fully convey the concept of the invention to those skilled in the art. Thus, the invention will be defined only by the scope of the appended claims. Like numbers refer to like elements throughout the following description herein.

In addition, the embodiments described herein will be described with reference to cross-sectional views and/or plan views, which are ideal illustrations of the invention. In the drawings, the thicknesses of films and regions are exaggerated for an effective description of the technical concept. Thus, the shapes of the illustrations may vary according to manufacturing techniques and/or tolerances. Therefore, the embodiments of the invention are not limited to the specific forms illustrated, but include changes in the forms occurring in the manufacturing process. For example, etched regions illustrated at right angles may be rounded or curved with a certain curvature. Thus, regions illustrated in the drawings have schematic attributes, and the shapes of the regions illustrated in the drawings are intended to illustrate specific shapes of regions of elements and are not intended to limit the scope of the invention.

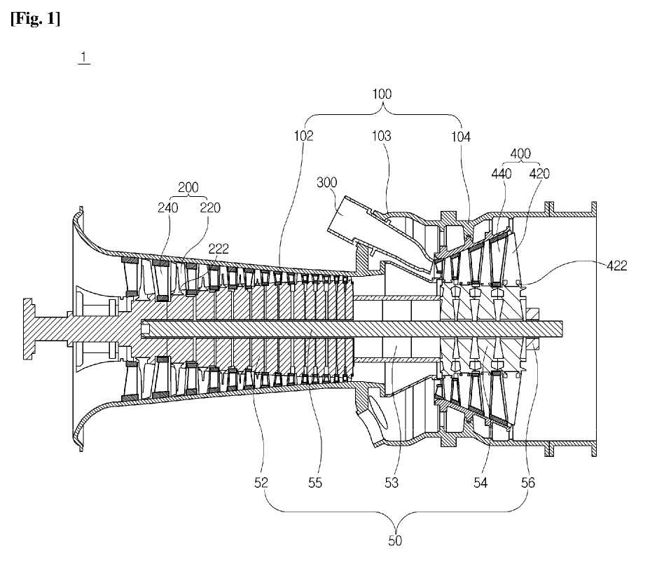

FIG. 1 schematically illustrates the structure of a gas turbine according to an embodiment of the present invention;

Referring to FIG. 1, a gas turbine 1 includes a casing 100, a compressor 200, a combustor 300, and a turbine 400. The casing 100 is shaped to surround the compressor 200, the combustor 300, and the turbine 400. The compressor 200 takes air in, compresses the air to produce compressed air with a high pressure, and supplies the compressed air to the combustor 300. The combustor 300 mixes the compressed air and fuel to combust the fuel-and-air mixture, and supplies high-temperature, high-pressure combustion gas generated through the combustion to the turbine 400. In the turbine 400, a plurality of turbine blades are rotated by the high-temperature high-pressure combustion gas. The torque generated by the turbine 400 is used to generate electric power.

The casing 100 includes a compressor casing 102 for accommodating the compressor 200, a combustor casing 103 for accommodating the combustor 300, and a turbine casing 104 for accommodating the turbine 400. The configuration of the casing is not limited to this. Alternatively, the compressor casing, the combustor casing, and the turbine casing are formed as a unitary body. The compressor casing 102, the combustor casing 103, and the turbine casing 104 are arranged in this order in a direction in which fluid flows.

A rotor (central shaft) 50 is rotatably provided in the casing 100. An electric generator (not illustrated) for generating electricity is connected to the rotor 50. A diffuser is provided at the downstream end of the casing 100 to discharge the combustion gas passing through turbine 400.

The rotor 50 includes a compressor rotor disk 52, a torque tube 53, and a turbine rotor disk 54. The compressor rotor disk 52 is received in the compressor casing 102 and the turbine rotor disk 54 is received in the turbine casing 104. The torque tube 53 is received in the combustor casing 103 and couples the compressor rotor disk 52 and the turbine rotor disk 54. The compressor rotor disk 52, the torque tube 53, and the turbine rotor disk 54 are fastened by a tie rod 55 and a fixing nut 56.

The compressor rotor disk 52 consists of plural (for example, fourteen) compressor rotor disks. The plural compressor rotor disks 52 are arranged in an axial direction of the rotor 50. The compressor rotor disks 52 are arranged in multiple stages. Each of the compressor rotor disks 52 has a disk shape. The outer circumferential surface of each of the compressor rotor disks 52 is provided with multiple blade coupling slots into which respective compressor blades 220, which will be described later, are planted.

The turbine rotor disk 54 has the substantially same structure as the compressor rotor disk 52. That is, plural turbine rotor disks 54 are arranged in the axial direction of the rotor 50. The turbine rotor disks 54 are also arranged in multiple stages. Each of the turbine rotor disks 54 has a disk shape. The outer circumferential surface of each turbine rotor disk 54 is provided with multiple blade coupling slots into which respective turbine blades 420, which will be described later, are planted.

The torque tube 53 is a torque transmitting member that transmits the rotational force of the turbine rotor disks 54 to the compressor rotor disks 52. A first end of the torque tube 53 is coupled to the rearmost compressor rotor disk 52 positioned at the most downstream end of the compressor in the direction of air flow among the multiple compressor rotor disks 52. A second end of the torque tube 53 is coupled to the foremost turbine rotor disk 54 positioned at the most upstream end of the turbine among the multiple turbine rotor disks 54. Each of the first and second ends of the torque tube 53 is provided with a protrusion. The rearmost compressor rotor disk 52 and the foremost turbine rotor disk 54 are provided with respective recesses to engage with the protrusions of the torque tube 53, respectively. This coupling structure prevents relative rotation of the torque tube 530 with respect to the compressor rotor disk 52 and the turbine rotor disk 54.

The torque tube 53 has a hollow cylinder form so that the compressed air supplied from the compressor 200 can pass through torque tube 53 to enter the turbine 400. Since a gas turbine normally continuously operates for a long period, the torque tube 53 needs to be highly durable so as not to experience deformation, distortion, and the like. In addition, the torque tube 530 is required to be easily assembled and disassembled for easy maintenance.

The tie rod 55 extends through the multiple compressor rotor disks 52, the torque tube 53, and the multiple turbine rotor disks 54. A first end of the tie rod 55 is coupled to the inner surface of the foremost compressor rotor disk 52 positioned at the most upstream end of the compressor in the direction of air flow among the multiple compressor rotor disks 52. A second end of the tie rod 55 protrudes from the outer surface of the rearmost turbine rotor disk 54 positioned at the most downstream end of the turbine in the flow direction of combustion gas among the multiple turbine rotor disks 54. The fixing unit 56 is fitted on the second end of the tie rod 55.

The fixing nut 56 is tightened to press the rearmost turbine rotor disk 54 toward the compressor 200. As the fixed nut 56 is forcefully tightened, the distance from the foremost compressor rotor disk 52 disposed at the most upstream side and the rearmost turbine rotor disk 54 disposed at the most downstream side is reduced. That is, the multiple compressor rotor disks 52, the torque tube 53, and the multiple turbine rotor disks 54 are compactly arranged in this order in the axial direction of the rotor 50. Therefore, the axial movement and relative rotation of the multiple compressor rotor disks 52, the torque tube 53, and the multiple turbine rotor disks 54 are prevented.

Although the present embodiment presents the structure in which one tie rod extends through the multiple compressor rotor disks, the torque tube, and the multiple turbine rotor disks, the present invention is not limited thereto. In another embodiment, the compressor and the turbine may be provided with respective tie rods. In a further embodiment, multiple tie rods may be arranged in a circumferential direction. In addition, a combination of those types is also possible. The ends of the rotor 50 are rotatably supported by respective bearings. One end of the rotor 50 is connected to a drive shaft of an electric generator.

The compressor 200 further includes compressor blades 220 and compressor vanes 240. The compressor blades 220 and the rotor 50 rotate together. The compressor blades 240 are fixed to the inner surface of the casing 100 to guide and align the flow of air to enter the next stage compressor blades 220.

The compressor blades 220 are provided in multiple stages arranged in the axial direction of the rotor 50. In each stage, the compressor blades 220 are radially arranged in a rotation direction of the rotor 50. Specifically, the root member 222 of each compressor blade 220 is retained in a corresponding one of the compressor blade coupling slots of the compressor rotor disk 52. The root member 222 has a fir-tree shape so as not to be escape from the compressor blade coupling slot in the radial direction of the rotor 50. In this case, the compressor blade coupling slot has a fir-tree shape corresponding to the shape of the root member 222 of the compressor blade.

Although the present embodiment provides a configuration in the compressor blade root members 222 and the compressor blade coupling slots have a fir-tree shape, the present invention is not limited thereto. That is, the compressor blade root members and the compressor blade coupling slots may have a dovetail shape. Alternatively, the compressor blades can be coupled to the compressor rotor disk 52 by a different type of coupling member such as a key or a bolt.

Typically, the compressor blades 220 are tangentially or axially coupled to the compressor rotor disk 52. In the present embodiment, the compressor blade root members 222 are of a so-called axial type. That is, the compressor blade root members 220 are inserted into the compressor blade coupling slots, respectively, in the axial direction of the rotor 50. In the present embodiment, each compressor rotor disk has multiple compressor blade coupling slots which are radially formed and arranged at predetermined intervals in a circumferential direction of the compressor rotor disk 52.

There are two or more compressor vanes 240. The compressor vanes 240 are provided in multiple stages arranged in the axial direction of the rotor 50. The compressor vanes 240 and the compressor blades 220 are alternately arranged in the direction of flow of air.

In each stage, the compressor vanes 240 are radially arranged in the rotation direction of the rotor 50.

The combustor 300 mixes and burns fuel and compressed air supplied from the compressor 200 to produce high-temperature high-pressure combustion gas having a high energy level. Specifically, plural combustors 300 are included in the gas turbine. The combustors 300 are received in the combustor casing 103 and arranged in the rotation direction of the rotor 50.

Each of the combustors 300 includes a liner into which the compressed is introduced from the compressor 200, a burner that jets fuel toward the compressed air introduced into the liner and burns the fuel and air mixture to produce combustion gas, and a transition piece that guides the combustion gas to the turbine 400.

The liner includes a flame tube serving as a combustion chamber and a flow sleeve surrounding the flame tube to form an annulus space.

The burner includes a fuel spray nozzle and an ignition plug. The spray nozzle is disposed in a front region of the liner to spray fuel toward the compressed air introduced into the combustion chamber. The ignition plug is provided in the wall of the liner to ignite the fuel-and-air mixture in the combustion chamber.

The transition piece is structured such that its outer wall is cooled by the compressed air supplied from the compressor 200. Since the outer wall of the transition piece is cooled by cooling air, the transition piece can endure the high temperature of the combustion gas without being damaged. The outer wall of the transition piece is provided with cooling holes through which cooling air is introduced into the transition piece. This cooling air introduced through the cooling holes cools the main body of the transition piece.

The cooling air passes through the transition piece and flows into the annular space of the liner. Cooling air is externally introduced into the annular space inside the flow sleeve through cooling holes formed in the flow sleeve, thereby cooling the outer surface of the liner.

Although not illustrated in the drawings, a deswirler serving as a guide vane is provided between the compressor 200 and the combustor 300. The deswirler adjusts a flow angle of air flowing into the combustor 300 to meet a designed flow angle.

The turbine 400 has the substantially same structure as the compressor 200. The turbine 400 includes turbine blades 420 and turbine vanes 440. The turbine blades 420 and the rotor 40 rotate together. The turbine vanes 440 are fixed to the inner surface of the casing 100 to guide and align the flow of air to be supplied to the next stage turbine blades 420.

Each turbine stage includes a plurality of turbine blades 420. That is, the turbine blades 420 are provided in multiple stages arranged in the axial direction of the rotor 50. In one embodiment of the present invention, the turbine consists of four stages of turbine blades 420. In the axial direction of the rotor 50, i.e., in the direction in which air flows, first stage turbine blades 424, second stage turbine blades 425, third stage turbine blades 426, and fourth stage turbine blades 427 are arranged in this order. However, it should be understood that the present invention is not limited to this configuration, and the number of stages of turbine blades provided in a turbine may be more than or fewer than four. In each stage, the turbine blades 420 are radially arranged in the rotation direction of the rotor 50.

The root member 422 of each turbine blade 420 is retained in a corresponding one of the turbine blade coupling slots provided in the outer surface of the turbine rotor disk 54. The root members 422 have a fir-tree shape so as not to escape from the turbine blade coupling slots in the radial direction of the rotor 50. In this case, the turbine blade coupling slots also have a fir-tree shape corresponding to the shape of the turbine blade root members 422.

Although the present embodiment provides a configuration in which the turbine blade root members 422 and the turbine blade coupling slots have a fir-tree shape, the present invention is not limited thereto. That is, the turbine blade root members 422 and the turbine blade coupling slots may have a dovetail shape. Alternatively, turbine blades 420 are coupled to the turbine rotor disk 54 by a different type of coupling member such as a key or a bolt.

Typically, turbine blades 420 are tangentially or axially coupled to the turbine rotor disk 54. In the present embodiment, the turbine blade root members 422 are of a so-called axial type. That is, the turbine blade root members 422 are inserted into the turbine blade coupling slots, respectively, in the axial direction of the rotor 50. In the present embodiment, each of the turbine rotor disks has multiple turbine blade coupling slots which are radially arranged at predetermined intervals in a circumferential direction of the turbine rotor disk 54.

The turbine includes a plurality of turbine vanes 440 provided in multiple turbine stages arranged in the axial direction of the rotor 50. The turbine vanes 440 and the turbine blades 420 are alternately arranged in the direction of flow of air.

In one embodiment of the present invention, the turbine blades 420 are arranged in four stages and the turbine vanes 440 are arranged in four stages. In the axial direction of the rotor 50, i.e., in the direction in which air flows, first stage turbine vanes 444, second stage turbine vanes 445, third stage turbine vanes 446, and fourth stage turbine vanes 447 are arranged in this order. However, it should be understood that the present invention is not limited to this configuration, and the number of stages of turbine vanes provided in a turbine may be more than or fewer than four. In each stage, the turbine vanes 440 are radially arranged in the rotation direction of the rotor 50.

Unlike the compressor 200, the turbine 400 needs to be equipped with a cooling unit which prevents the turbine 400 from being damaged or degraded by heat of the high-temperature high-pressure combustion gas because the turbine 400 comes into direct contact with the high-temperature high-pressure combustion gas. The gas turbine 1 according to the present embodiment includes an external cooling system that feeds a portion of the compressed air generated by the compressor 200 to the turbine 400 from the outside of the casing 100.

The gas turbine 1 is configured such that air is first introduced into the casing 100 and then compressed by the compressor 200, the compressed air generated by the compressor 200 is mixed with fuel and burned by the combustor 300, and the combustion gas generated by the combustor 300 is introduced into the turbine 400. The combustion gas introduced into the turbine 400 rotates the rotor 50 while passing the turbine blades 420. Finally, the combustion gas is discharged into the atmosphere through a diffuser. The rotor 50 rotated by the combustion gas drives the compressor 200 and the electric generator. That is, part of the mechanical energy generated by the turbine 400 is used as an energy source for air compression by the compressor 200 and the other part is used as an energy source for generation of electricity by the electric generator.

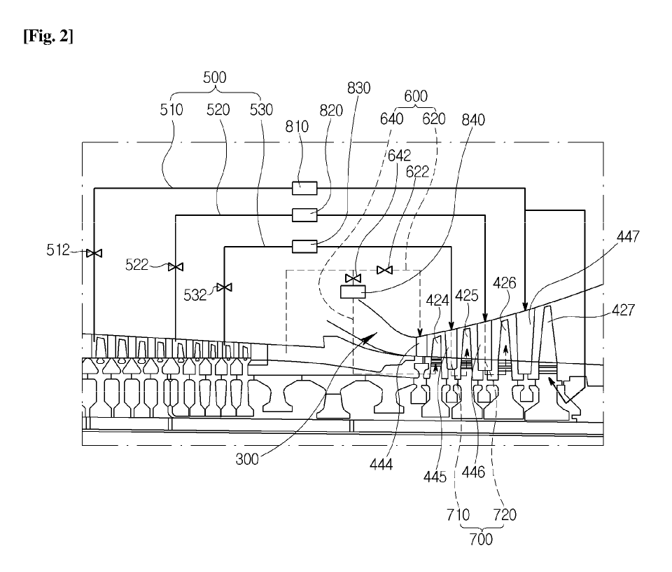

FIG. 2 illustrates a cooling system for a gas turbine of FIG. 1;

Referring to FIGS. 1 and 2, the gas turbine cooling system includes: a plurality of external cooling passages 500 for bleeding the compressed air to the outside of the casing 100 from the compressor 200 at several positions and for supplying the extracted compressed air to the turbine 400; an outlet-side cooling passage 600 for bleeding the compressed air from an outlet of the compressor 200 and supplying the extracted compressed air to the turbine 400; and a connection cooling passage 700 between the turbine blades 420 and the turbine blades 400 provided at the same stage.

Hereinafter, cooling of a turbine with four stages, each stage including the turbine blades 420 and the turbine vanes 440, will be described. However, it should be understood that the present invention is not limited to this configuration, and this cooling method can be applied to a turbine with fewer than or more than four stages of turbine vanes and blades.

The outlet-side cooling passage 600 supplies air to the first stage turbine vanes 444 of the four stages of turbine vanes 440 and the first stage turbine blades 424 of the four stages of turbine blades 420. That is, the outlet-side cooling passage 600 includes an outlet-side external cooling passage 620 for supplying air to the first stage turbine vanes 444 and an outlet-side internal cooling passage 640 for supplying air to the first stage turbine blades 424.

Specifically, the outlet-side external cooling passage 620 bleeds the compressed air to the outside of the casing 100 from the outlet of the compressor 200 and directly supplies the compressed air to the first stage turbine vanes 444. The outlet-side internal cooling passage 640 is provided at a lower end of the first stage turbine blade 424 such that the compressed air is bled from the outlet of the compressor 200 to an internal space of the casing 100 and is then supplied to the lower end of the first stage turbine blade 424. Since the compressed air bled from the outlet of the compressor 200 is supplied to the first stage turbine vane 444 and the first stage turbine blade 424 to cool the first stage turbine vane 444 and the first stage turbine blade 424.

In this case, the air supplied through the outlet-side external cooling passage 620 is directly supplied to the first stage turbine vane 444 without undergoing any heat exchange, but a fourth cooler 840 is disposed on the outlet-side internal cooling passage 640. That is, since the additionally provided fourth cooler 840 cools the air supplied through the outlet-side internal cooling passage 640, the first stage turbine blade 424 can be more efficiently cooled.

In addition, at least one cooling air control valve is provided at the inlet or on the flow path of the outlet-side external cooling passage 620 and the outlet-side internal cooling passage 640. In the present embodiment, two cooling air control valves 622 and 642 are provided on the flow path of the outlet-side external cooling passage 620 and the flow path of the outlet-side internal cooling passage 640, respectively.

Accordingly, the flow rate of the cooling air supplied to the first stage turbine vane 444 and the first stage turbine blade 424 can be easily adjusted.

The multiple external cooling passages 500 supply air to at least one turbine vane among the multiple turbine vanes 440 excluding the first stage turbine vanes 444, and to at least one turbine blade where the connection cooling passage 700 is not provided, among the multiple turbine blades excluding the first stage turbine blades 424. Specifically, the multiple external cooling passages 500 supply air to the second stage turbine vane 445, the third stage turbine vane 446, and the fourth stage turbine vane 447. In addition, a second stage pair of turbine vane and turbine blade and a third stage pair of turbine vane and turbine blade are provided with the respective connection cooling passages 700. Therefore, the multiple external cooling passages 500 supply air to the fourth stage turbine blade 427 in which the connection cooling passage 700 is not provided, among the multiple stages of turbine blades 424 excluding the first stage turbine blade. In other words, the multiple external cooling passages 500 include a first external cooling passage 510 for supplying air to the fourth stage turbine vane 447 and the fourth stage turbine blade 427, a second external cooling passage 520 for supplying air to the third stage turbine vane 446, and a third external cooling passage 530 for supplying air to the second stage turbine vane 445.

In this case, the first to third external cooling passages 510, 520, and 530 respectively bleed air from the compressor 200 at different positions and supply the extracted air to the turbine 400, sequentially from a relatively far region to a relatively near region of the turbine with respect to the compressor. That is, the compressor 200 is divided into a front stage, an intermediate stage, and a rear stage. The air is bled from the front stage, the intermediate stage, and the rear stage of the compressor 200 and supplied to the first, second, and third cooling passages 510, 520, and 530.

In the present embodiment, a cooling passage for supplying air to the fourth stage turbine vane 447 and the fourth stage turbine blade 427 branches off from the first external cooling passage 510. However, the present invention is not limited to this.

The multiple external cooling passages 500 and the outlet-side cooling passages 600 are connected to the internal cooling passages of the turbine blades or the turbine vanes to which cooling air is to be supplied. The internal cooling passages communicate with film cooling holes formed in the surface of each of the turbine blades and the turbine vanes. Cooling air supplied through the cooling passages can reach the surface of each of the turbine blades and the turbine vanes. Therefore, the inside and outside of the turbine vanes and the turbine blades can be cooled.

The connection cooling passage 700 is provided between the turbine vane 440 and the turbine blades 420. Therefore, it is possible to cool both the turbine vane 440 and the turbine blade 420 provided in the same stage with cooling air supplied to the turbine vane 440. The connection cooling passage 700 connects the internal cooling passage of the turbine blade 420 and the internal cooling passage of the turbine vane 440 provided in the same stage, so that a cooling circuit is formed. The connection cooling passage 700 is connected to a lower end of the turbine blade 420 and to a lower end of the turbine vane 440 provided at the same stage so that air is introduced into the turbine vane and the turbine blade through the lower ends of the turbine vane and the turbine blade. Specifically, the connection cooling passage 700 is configured such that cooling air suppled to the turbine vane 440 flows downward to the lower end the turbine vane 440, then resides in the space of a U-ring disposed at the lower end of the turbine vane 440 or in the space of the turbine rotor disk 54, then flows to the lower end (i.e., the root member 422) of the turbine blade 420 located at the same stage as the turbine vane 440, and finally flows upward to the upper end of the turbine blade 420.

In the present embodiment, the second stage and the third stage are provided with the connection cooling passages 700. That is, the connection cooling passages include a first connection cooling passage 710 connecting the cooling passage of the second stage turbine vane 445 and the cooling passage of the second stage turbine blade 425 and a second cooling passage 720 connecting the cooling passage of the third stage turbine vane 446 and the cooling passage of the third stage turbine blade 426.

Accordingly, even though the cooling air is supplied only to the third stage turbine vane 446 and the second stage turbine vane 445 respectively through the second external cooling passage 520 and the third external cooling passage 530, the third stage turbine blade 426 and the second stage turbine blade 425 can be cooled because the cooling air is transferred from the third stage turbine vane 446 and the second stage turbine vane 445 to the third stage turbine blade 426 and the second stage turbine blade 425 through the second connection cooling passage 720 and the first connection cooling passage 710.

A second cooler 820 and a third cooler 830 are disposed on the second external cooling passage 520 and the third external cooling passage 530, respectively, to cool the air supplied through the cooling passages. Therefore, the turbine blade and the turbine vane can be cooled more efficiently.

In addition, a first cooler 810 is disposed on the first external cooling passage 510 to cool the air supplied through the external cooling passage. Therefore, the turbine vane and the turbine blade can be cooled more efficiently. However, the present invention is not limited to this configuration, and the first cooler may be omitted.

The first to fourth coolers 810, 820, 830, and 840 can cool the air flowing through the corresponding cooling passages to different temperatures. That is, the cooling efficiency can be increased by adaptively cooling the cooling air to an appropriate temperature according to the temperature of the turbine blade 420 or the turbine vane 440 to which the cooling air is to be supplied through the cooling passage.

In addition, at least one cooling air control valve is provided at the inlet or in the flow path of each of the first to third external cooling passages 510, 520, and 530. In the present embodiment, the first to third external cooling passages 510, 520, and 530 are provided with cooling air control valves 512, 522, and 532, respectively.

Accordingly, the flow rate of the cooling air supplied to the turbine blades and the turbine vanes at each stage can be easily controlled. That is, the temperature of each component of the turbine is monitored by using sensors provided in the electric power generator, and the flow rate of the cooling air supplied to each component is controlled.

Pre-swirlers (not illustrated) are installed on the outlet-side internal cooling passage 640 and the connection cooling passages 700 at the second stage and the third stage. Specifically, the pre-swirlers are disposed at a position near an air inlet positioned at the lower end of the first stage turbine blade 424, a position near an air inlet positioned at the lower end of the second stage turbine blade 425, and a position near an air inlet near the lower end of the third stage turbine blade 426, respectively. However, the present invention is not limited to this configuration. That is, a pre-swirler may be provided to each of only one or two of the positions at which the air enters the lower ends of the first stage to third stage turbine blades 424 to 426.

An additional cooling passage called a turbine cooling passage (not illustrated) for supplying cooling air into the turbine 400 may be provided. The turbine cooling passage functions to cool the surfaces of the turbine casing 104, the turbine blade 420, and the turbine vane 440 by supplying cooling air to the turbine 400.

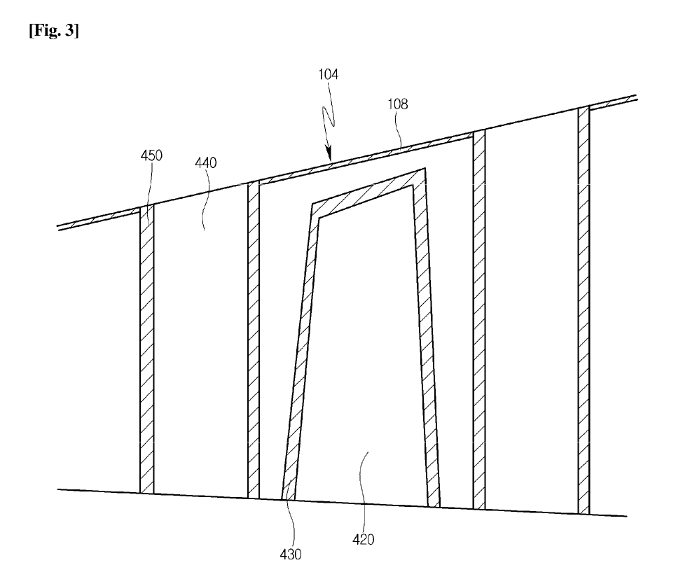

FIG. 3 is an enlarged view of a region in the casing of FIG. 1.

Referring to FIGS. 1 and 3, coating layers 108, 430, and 450 are provided on the surfaces of respective components of the gas turbine 1. The coating layers 108, 430, 450 are formed on surfaces of the compressor 200 and the turbine 400, among the components of the gas turbine 1, and preferably, the coating layers 108, 430, and 450 are formed on the surface of the turbine 400.

Specifically, the coating layer 108 is provided on the inner surface of the turbine casing 104, the coating layer 430 is provided on the outer surface of the turbine blade 420, and the coating layer 450 is provided on the outer surface of the turbine vane 440. That is, the turbine 400 is provided with one or more coating layers of the casing coating layer 108, the blade coating layer 430, and the vane coating layer 450.

The coating layers 108, 430, and 450 each have properties in which the resistance value changes with temperature and include a heat shielding coating material and a resistive material whose resistance value varies with temperature. For example, the heat shielding coating material may be molybdenum, stainless steel, quartz, or the like. For example, the resistive material is platinum, platinum-rhodium, platinum-iridium, nickel, or a tungsten oxide. For example, the coating layers 108, 430, and 450 are formed of a mixture of a heat shielding material and a resistive material and are formed in such a manner as to be applied to the surface of one component of the turbine 400. Alternatively, the coating layers 108, 430, and 450 are formed such that the heat shielding material and the resistive material are separated from each other, and the resistive material is disposed within the heat shielding material. In this case, the resistive material is embedded in the form of a wire in the heat shielding material. The resistive material has a positive temperature coefficient (PTC) characteristic. That is, the resistance increases as the temperature increases. Generally, when the temperature of a resistive material increase, the number of free electrons increases, resulting an increase in likelihood of collision between the free electrons. This means that the resistance increases. Accordingly, as the temperature of the coating layers 108, 430, and 450 increases, the temperature of the resistive material increases. Therefore, the resistance of the resistive material (i.e., the coating layers 108, 430, and 450) increases.

Each of the coating layers 108, 430, and 450 is electrically connected to a measuring unit (not illustrated) described later, which measures a resistance value that changes with temperature of the corresponding coating layer.

According to an embodiment of the present invention, the coating layers are formed of a resistance variable material whose resistance value changes with temperature, and the temperature of one component of the turbine 400 is estimated by measuring the resistance value of the component of the turbine 400. Generally, components provided within the turbine 400 are exposed to high temperature environments, and conventional temperature sensors are difficult to use in high temperature environments. However, according to the embodiment of the present invention, the resistance value of the coating layer can be measured and the temperature of the components within the turbine 400 can be estimated on the basis of the resistance value. Since the components of the turbine 300 can be estimated, a turbine cooling system can be efficiently operated, and it is possible to identify which components of the turbine need to be cooled.

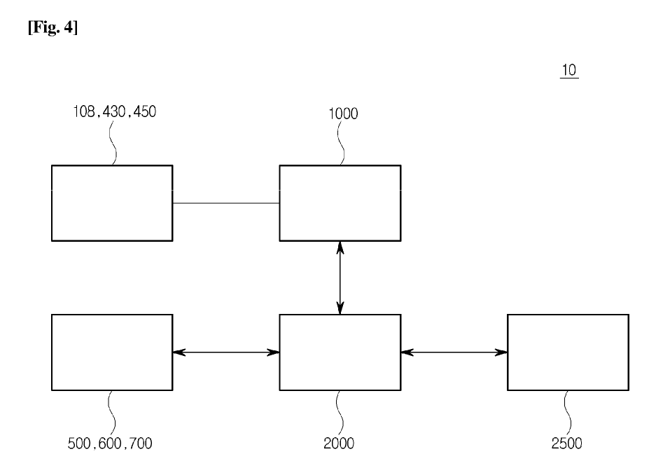

FIG. 4 illustrates a turbine temperature estimation system according to an embodiment of the present invention. For the sake of simplicity of description, duplication of detailed descriptions of same components will be avoided.

Referring to FIGS. 1 to 4, a turbine temperature estimation system 10 includes coating layers 108, 430, and 450, cooling passages 500, 600, and 700, a measuring unit 1000, a controller 2000, and a data storage device (i.e., memory) 2500 in which a temperature table is stored. The coating layer 108, 430, or 450 is formed on the surface of at least one of a turbine blade 420, a turbine vane 440, and a turbine casing 104 of a turbine 400. Thus, the coating layers include one or more of a casing coating layer 108, a blade coating layer 430, and a vane coating layer 450, and in the turbine 400, at least one of the casing coating layer 108, the blade coating layer 430, and the vane coating layer 450 is provided. The blades 420 and the vanes 440 are each divided into a plurality of stages. According to an embodiment of the present invention, the blades 420 and the vanes 440 are each divided into four stages.

The cooling passages include external cooling passages 500, outlet-side cooling passages 600, connection cooling passages 700, and a turbine cooling passage (not illustrated). Each of the external cooling passage 500, the outlet-side cooling flow passage 600, and the connection cooling passage 700 may include more than one passage.

The measuring unit 1000 measures a change in resistance value of the coating layers 108, 430, and 450 disposed on the surfaces of the respective components of the turbine 400. For example, the measuring unit 1000 applies an electric current to each of the coating layers 108, 430, and 450, measures voltage values of the respective coating layers, and derives the resistance values of the respective coating layers on the basis of the voltage values. As another example, the measuring unit 1000 applies an electric current to resistive materials disposed in the respective coating layers 108, 430, and 450, measures voltage values of the resistive materials, and derives the resistance values of the resistive materials on the basis of the voltage values.

The controller 2000 estimates the temperatures of the coating layers 108, 430, and 450 on the basis of the resistance values provided by the measuring unit 1000. Specifically, the controller 2000 estimates the temperatures of the components of the turbine 400 by finding temperatures associated with the voltage values of the coating layers 108, 430, and 450 from data recorded in the temperature table of the data storage device 2500. That is, the controller 2000 determines that the temperatures of the respective coating layers 108, 430, and 450 are temperatures of the respective components of the turbine 400. For example, the controller 2000 compares the resistance value of the casing coating layer 108 with the data of the temperature table of the data storage device 2500, and determines the temperature of the casing coating layer 108 as the temperature of the turbine casing 104. The controller 2000 compares the resistance value of the blade coating layer 430 with the data of the temperature table and determines the temperature of the blade coating layer 430 as the temperature of the blade 420. The controller 2000 compares the resistance value of the vane coating layer 450 with the data of the temperature table and determines the temperature of the vane coating layer 450 as the temperature of the vane 440.

The temperature table of the data storage device 2500 contains data in which the temperatures of each of the components of the turbine 400 are the resistance values of each of the coating layers 108, 430, and 450 are mapped. That is, the temperature table contains temperatures corresponding resistance values of the casing coating layer 108, temperatures corresponding to the resistance values of the blade coating layer 430, and temperatures corresponding to the resistance values of the vane coating layer 450.

The controller 2000 adaptively controls the opening of each of the cooling passages 500, 600, and 700 according the temperature of the turbine 400. Specifically, the controller 2000 controls the opening of at least one of the external cooling passages 500, the outlet-side cooling passages 600, the connection cooling passages 700, and the turbine cooling passage (not illustrated) to cool at least one of the blades 420, the vanes 440, and the casing 104 of the turbine 400 on the basis of the resistance values of the coating layers 108, 430, and 450.

The controller 2000 estimates the temperature of one component of the turbine 400 and compare the estimated temperature with the designed temperature of the component of the turbine 400. The controller 2000 increases the opening degree of a valve provided in the cooling passage that supplies cooling air to one component of the turbine 400 when the estimated temperature of the component of the turbine 400 is higher than the designed temperature. Conversely, the controller 2000 decreases the opening degree of the valve provided in the cooling passage that supplies cooling air to a component of the turbine 400 when the estimated temperature of the component of the turbine 400 is lower than the designed temperature. In this case, the increase or decrease in the opening degree of the valve is determined on the basis of the current opening degree of the valve. Here, the components of the turbine 400 refer to at least one of the inner casing 104, the blade 420, and the vane 440. The controller 2000 estimates the temperature of at least one of the casing coating layer 108, the blade coating layer 430, and the vane coating layer 450, and controls at least one of the values provided in the cooling passages 500, 600, and 700 that supplies cooling air to the casing coating layer 108, the blade coating layer 430, and the vane coating layer 450.

For example, the controller 2000 estimates the temperature of the casing coating layer 108 and controls the valve of the turbine cooling passage (not illustrated). That is, when the temperature of the casing coating layer 108 is higher than the designed temperature, the controller 2000 increases the opening degree of the valve of the turbine cooling passage (not illustrated), and when the temperature of the casing coating layer 108 is lower than the designed temperature, the controller 2000 decreases the opening degree of the valve of the turbine cooling channel (not illustrated).

As another example, the controller 2000 controls the valves of the external cooling passages 500, the outlet-side cooling passages 600 and the connection cooling passages 700 by estimating the temperatures of the blade coating layer 430 and the vane coating layer 450. That is, when the temperatures of the blade coating layer 430 and the vane coating layer 450 are higher than the designed temperature, the controller 2000 increases the opening degree of each of the valves of the external cooling passages 500, the outlet-side cooling passages 600, and the connection cooling passages 700. Conversely, the controller 2000 decreases the opening degree of each of the values of the external cooling passages 500, the outlet-side cooling passages 600, and the connection cooling passages 700 when the temperatures of the blade coating layer 430 and the vane coating layer 450 are lower than the respective designed temperatures.

As a further example, the controller 2000 estimates the coating layers 430 and 450 on the surface of the blades 420 and the vanes 440 provided in one or more stages, and controls the opening and closing of the external cooling passages 500 and the outlet-side cooling passages 600. Specifically, the controller 2000 controls the valve of the outlet-side internal cooling passage 640 for cooling a first stage turbine blade 424 among the outlet-side cooling passages 600 on the basis of the resistance value of the coating layer 430 on the surface of the first stage turbine blade 424. That is, the controller 2000 estimates the temperature of the coating layer 430 on the surface of the first stage turbine blade 424 and controls the opening and closing of the outlet-side internal cooling passage 640. The controller 2000 controls the opening of the valve of the outlet-side external cooling passage 620 for cooling a first stage turbine vane 545 among the outlet-side cooling passages 600 on the basis of the resistance value of the coating layer 450 on the surface of the first stage turbine vane 444 of the turbine 400. That is, the controller 2000 estimates the temperature of the coating layer 450 on the surface of the first stage turbine vane 444 and controls the opening and closing of the outlet-side external cooling passage 620. The controller 2000 controls the valves of the external cooling passages 500 and the connection cooling passages 700 on the basis of the resistance values of the coating layers 430 and 450 on the surfaces of the blades 425, 426, and 427 and the surfaces of the vanes 445, 446, and 447 except for the coating layers on the surfaces of the first stage blades 424 and the first stage vanes 444. That is, the controller 2000 estimates the temperatures of the coating layers 430 and 450 on the surfaces of the second stage to fourth stage blades 425, 426, and 427 and the second stage to fourth stage vanes 445, 446, and 447 and controls the opening of each of the external cooling passages 500 and the connection cooling passages 700.

Unlike the above-described examples, the cooling passage may be composed of a first cooling passage for cooling only the blade 420, a second cooling passage for cooling only the vane 440, and a third cooling passage for cooling the turbine casing 140. The configuration of the cooling passages is not limited to the above-described examples. An embodiment of the present invention is directed to a method of cooling each of the coating layers on the basis of the temperatures of the casing coating layer 108, the blade coating layer 430, and the vane coating layer 450.

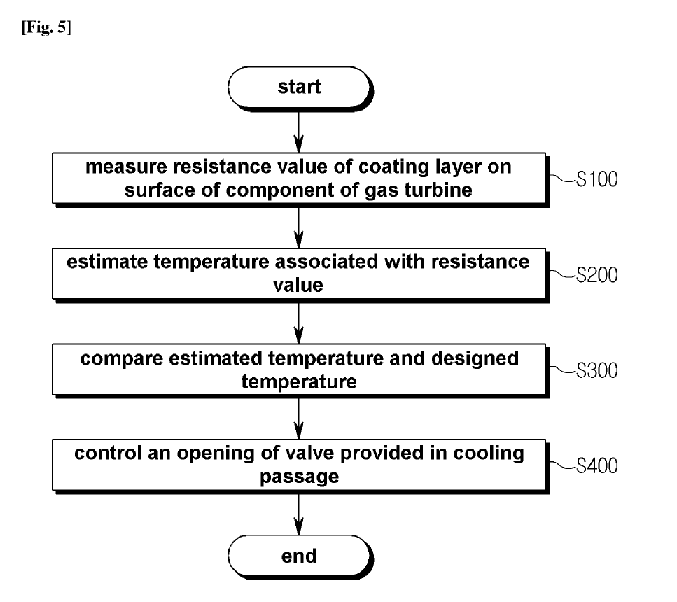

FIG. 5 illustrates a method of estimating the temperature of a turbine according to an embodiment of the present invention.

Referring to FIG. 5, the measuring unit measures the resistance value of a coating layer provided on one component of a gas turbine. The component of the gas turbine is at least one of a turbine casing, a turbine vane, and a turbine blade. The measuring unit measures the resistance values of the coating layer, which changes with temperature or measures the resistance value of a resistive material provided within the coating layer, which changes with temperature (Step S100).

The controller associates the resistance value measured by the measuring unit with the temperature recorded in the temperature table. This allows the controller to infer the temperature of one component of a gas turbine. The temperature table contains data composed of resistance values and associated temperatures of each coating layer on a corresponding component of the various components of the gas turbine. In addition, the controller estimates the temperatures of the coating layers on the basis of the temperature table, and determines the temperatures of the coating layers as the temperatures of the respective components of the gas turbine (Step S200).

The controller compares designed temperatures with the estimated temperatures of the coating layers. The designed temperature refers to a temperature at which the component of the gas turbine works efficiently. That is, the designed temperature means a temperature at which the durability of the component of the gas turbine is not significantly deteriorated. However, the designed temperature is a preset temperature and is not specifically limited to the example described above. The designed temperature can be changed by the operator (Step S300).

The controller controls the opening of valves in respective cooling passages by comparing the designed temperatures with the estimated temperatures of the coating layers. The controller increases the opening degree of each valve provided in a corresponding one of the cooling passages that supplies cooling air to components of the turbine when the estimated temperature of the component is higher than the designed temperature. Conversely, the controller decreases an opening degree of each valve provided in a corresponding one of the cooling passages that supply cooling air to the components of the turbine when the estimated temperature is lower than the designed temperature (Step S400). While exemplary embodiments of the present invention have been described with reference to the accompanying drawings, those skilled in the art will appreciate that the present invention can be implemented in other different forms without departing from the technical spirit or essential characteristics of the exemplary embodiments. Therefore, it can be understood that the exemplary embodiments described above are only for illustrative purposes and are not restrictive in all aspects.

What is claimed is:

1. A system for estimating a temperature of a gas turbine, the system comprising:
a coating layer formed on a surface of a component of the gas turbine;
a measuring unit configured to supply an electric current to the coating layer and to measure a change in a resistance value of the coating layer; and
a controller configured to estimate a temperature of the coating layer on the basis of the resistance value,
wherein the coating layer comprises a heat shielding material and a resistive material whose resistance value changes with temperature.

2. The system according to claim 1, further comprising a cooling passage for supplying cooling air to cool the component of the gas turbine,
wherein the controller is further configured to control an opening of the cooling passage according to a voltage value of the coating layer.

3. The system according to claim 2, wherein the component of the gas turbine includes a blade,
the cooling passage supplies cooling air to the blade, and
the measuring unit measures the resistance value of the coating layer formed on an outer surface of the blade.

4. The system according to claim 2, wherein the component of the gas turbine includes a vane,
the cooling passage supplies cooling air to the vane, and
the measuring unit measures the resistance value of the coating layer formed on an outer surface of the vane.

5. The system according to claim 2, wherein the component of the gas turbine includes a casing,
the cooling passage injects cooling air into the casing, and
the measuring unit measures the resistance value of the coating layer formed on an inner surface of the casing.

6. The system according to claim 2, further comprising a valve provided in the cooling passage,
wherein the controller is further configured to control an opening degree of the valve by increasing the opening degree when the temperature of the component of the gas turbine is higher than a design value and by decreasing the opening degree when the temperature of the component of the gas turbine is lower than the design value.

7. The system according to claim 1, further comprising a data storage device for storing a temperature table in which resistance values of the coating layer and temperatures of the component of the gas turbine are mapped,
wherein the controller estimates the temperature of the component of the gas turbine by finding a temperature associated with a voltage value of the coating layer from the temperature table.

8. The system according to claim 1, wherein the resistive material includes one of platinum, platinum-rhodium, platinum-iridium, nickel, and a tungsten oxide.

9. The system according to claim 1, wherein the resistive material is embedded in the coating layer and has a wire form, and
the measuring unit supplies an electric current to the resistive material and measures a resistance value of the resistance material which changes according to the temperature of the coating layer.

10. A system for estimating a temperature of a turbine, the system comprising:
a coating layer formed on a surface of a component of the turbine;
a measuring unit configured to supply an electric current to the coating layer and to measure a change in a resistance value of the coating layer;
a controller configured to estimate a temperature of the coating layer on the basis of the resistance value; and
a cooling passage for cooling the component of the turbine,
wherein the coating layer comprises a heat shielding material and a resistive material whose resistance value changes according to a temperature, and the controller is configured to control an opening of the cooling passage according to a voltage value of the coating layer.

11. The system according to claim 10, wherein the cooling passage comprises:
a plurality of external cooling passages for bleeding air from a compressor to an outside of a compressor casing and for supplying the air to the turbine;
an outlet-side cooling passage for bleeding air from an outlet of the compressor and supplying the air to the turbine;
a connection cooling passage provided between a turbine blade and a turbine vane provided in a same stage; and
a turbine cooling passage for supplying air to an inside of the turbine.

12. The system according to claim 11, wherein the coating layer is disposed on a surface of a first stage turbine vane of the turbine, and
the controller controls an opening of an outlet-side external cooling passage for cooling the first stage cooling vane of the outlet-side cooling passages according to the resistance value of the coating layer which is measured by the measuring unit.

13. The system according to claim 11, wherein the coating layer is disposed on a surface of a first stage turbine blade of the turbine, and
the controller controls an opening of an outlet-side internal cooling passage for cooling the first stage cooling blade of the outlet-side cooling passages according to the resistance value of the coating layer which is measured by the measuring unit.

14. The system according to claim 11, wherein the coating layer is disposed on a surface of a turbine blade and a surface of a turbine vane other than a first stage turbine blade and a first stage turbine vane, and
the controller controls an opening of the outlet-side external cooling passage and the connection cooling passage according to the resistance value of the coating layer which is measured by the measuring unit.

15. The system according to claim 11, wherein the coating layer is disposed on a surface of a casing of the turbine, and
the controller controls an opening of the cooling passage according to the resistance value of the coating layer which is measured by the measuring unit.

16. The system according to claim 11, wherein the coating layer is disposed on a surface of at least one of a turbine blade, a turbine vane, and a casing of the turbine,
the controller obtains the resistance value of the coating layer disposed on the surface of at least one of the turbine blade, the turbine vane, and the casing of the turbine from the measuring unit, and
the controller controls at least one of the external cooling passage, the outlet-side cooling passage, the connection cooling passage, and the turbine cooling passage to cool at least one component of the turbine blade, the turbine vane, and the casing of the turbine according to the resistance value of the coating layer.

17. The system according to claim 10, wherein the resistive material is embedded in the coating layer and has a wire form,
the measuring unit supplies an electric current to the resistive material and measures a resistance value of the resistance material which changes according to the temperature of the coating layer, and
the resistive material includes one of platinum, platinum-rhodium, platinum-iridium, nickel, and a tungsten oxide.
